(19) United States
(12) Patent Application Publication
(10) Pub. No.: US 2014/0176309 A1
(43) Pub. Date: Jun. 26, 2014

(54) REMOTE CONTROL SYSTEM USING A HANDHELD ELECTRONIC DEVICE FOR REMOTELY CONTROLLING ELECTRICAL APPLIANCES

(71) Applicant: INSYDE SOFTWARE CORP., Taipei City (TW)

(72) Inventors: Chih-Kao WANG, Taipei City (TW); Chia-Ting Yu, Taipei City (TW); Wei-Jung Tang, Taipei City (TW)

(73) Assignee: INSYDE SOFTWARE CORP., Taipei City (TW)

(21) Appl. No.: 13/789,164

(22) Filed: Mar. 7, 2013

(30) Foreign Application Priority Data
Dec. 24, 2012 (TW) 101149479

(51) Int. Cl. G05B 13/02

(52) U.S. Cl. CPC G05B 13/02
USPC 340/12.5

(57) ABSTRACT

A remote control system using a handheld electronic device to remotely control electrical appliances includes a handheld electronic device and a command conversion device. The handheld electronic device uses a command input device to generate operation information. A command recognizing module receives the operation information, and identifies the corresponding home appliance remote control code. A wireless emission module emits a home appliance remote control code, which is received by the command conversion device. The command conversion device determines the infrared execution command corresponding to the home appliance remote control code. The infrared execution command is emitted by the infrared emission module to remotely control home appliances with the infrared remote control function. The handheld electronic device is enabled to provide a variety of different operating modes without significantly increasing the cost of the entire system.

### CROSS-REFERENCE TO RELATED APPLICATIONS

This application claims the benefit of Taiwan patent application No. 101149479, filed on Dec. 24, 2012, the disclosure of which is incorporated herein in its entirety by reference.

### BACKGROUND OF THE INVENTION

1. Field of the Invention

The invention relates to a remote control system and, in particular, to a remote control system using a handheld electronic device to remotely control electrical appliances.

2. Description of Related Art

With increasing types of home appliances available on the market, common home appliances such as TV sets, CD players, stereos, etc., all have remote control function. These home appliances are equipped with remote controls that emit infrared (IR) commands for the user to remotely control operations thereof.

Currently a smart remote control with a screen and an IR receiver is provided. The smart remote control is further built in with a learning mode to receive and store the IR commands of remote controls of various home appliances. Once the IR commands are recorded, the smart remote control can emit the corresponding IR commands to remotely control various appliances. Though having more functions compared to traditional remote controls, said smart remote control yet involves more complicated operations, such as setting up IR commands, downloading new information, updating software, and so on. In addition, the user must press the keys to operate the smart remote control, which is not user-friendly enough. Although some manufacturers further provide a mouse wheel on the smart remote control, the operation is still inconvenient and remarkably increases the cost of the smart remote control. Consumers are thus reluctant to purchase such smart remote controls.

In order to solve the operational problems, further provided are several smart home appliances that work with handheld electronic devices (for example, smart phones). As shown in FIGS. 6A and 6B, after a handheld electronic device 50 receives operational commands from a user, the handheld electronic device 50 emits corresponding operation information. The smart home appliance 60 has a central control 61, which includes a wireless receiving module 71, a command recognizing device 72, and a command execution module 73.

The wireless receiving module 71 receives operation information emitted by a handheld electronic device 50.

The command recognizing device 72 is coupled with the wireless receiving module 71 and connected with a command comparison server 80 via the Internet. After receiving the operation information, the operation information is output to the command comparison server 80. The command recognizing device 72 further receives an execution command corresponding to the operation information returned from the command comparison server 80.

The command execution module 73 is coupled with the command recognizing device 72 to execute the corresponding action upon receiving the execution command.

As handheld electronic devices are already widely used and normally come with a touch screen, operations of the handheld electronic devices are more convenient than those of the smart remote controls. However, as the handheld electronic devices are not designed for remotely controlling home appliances, the operation information output by the handheld electronic devices cannot be directly used to remotely control home appliances. The smart home appliances must link to the command comparison server and send the operation command (e.g., text message) emitted by the handheld electronic device to the command comparison server for recognition. After the comparison of the command comparison server, a corresponding execution command (such as channel selection, video recording setting, etc.) is sent back to the smart home appliance to execute the corresponding action. Such an operation does have an improved convenience but is only suitable for smart home appliances with Internet links, and hence the cost is much higher than cost of the smart remote control. Consequently, both smart remote controls and smart home appliances still have limited market acceptance.

### SUMMARY OF THE INVENTION

In view of the foregoing, the present invention provides a remote control system using a handheld electronic device to remotely control electrical appliances.

To achieve the above-mentioned objective, the disclosed remote control system includes: a handheld electronic device and a command conversion device.

The handheld electronic device has a command input device, a command recognizing module, and a wireless emission module. The command input device generates operation information. The command recognizing module is coupled with the command input device and the wireless emission module. The command recognizing module is built in with multiple sets of home appliance remote control codes. After receiving the operation information, the home appliance remote control code corresponding to the operation information is identified. The home appliance remote control code is processed as a wireless signal for the wireless emission module to emit.

The command conversion device includes a wireless receiving module, a processing module, and an IR emission module. The wireless receiving module receives a home appliance remote control code emitted by the handheld electronic device. The processing module is coupled with the wireless receiving module and the IR emission module. The processing module is built in with multiple sets of IR execution commands corresponding to the multiple sets of home appliance remote control codes. After receiving a home appliance remote control code, the command conversion device determines the IR execution command corresponding to the home appliance remote control code. The infrared emission module then emits the IR execution command.

In the remote control system using a handheld electronic device to remotely control electrical appliances, the user operates the handheld electronic device to determine the home appliance remote control code corresponding to the user's operation. After receiving the home appliance remote control code, the command conversion device emits a corresponding IR execution command. In addition to facilitating operational convenience, the invention can be used for a variety of home appliances with IR remote control without modifying any original installment of the home appliances. Moreover, the invention is not limited to smart home appliances in application. Accordingly the cost of the present invention is relatively low, thereby promoting market acceptance.

### BRIEF DESCRIPTION OF THE DRAWINGS

FIGS. 1A and 1B are respectively a block diagram of the system and a circuit using an electronic device to remotely control electrical appliances according to the invention;

FIGS. 2A and 2B are respectively a schematic view of an embodiment of the invention and a flowchart of remote control using a handheld electronic device;

FIGS. 3A and 3B are respectively a schematic view of another embodiment of the invention and a flowchart of remote control using a handheld electronic device;

FIGS. 4A and 4B are respectively a schematic view of yet another embodiment of the invention and a flowchart of remote control using a handheld electronic device;

FIG. 5 is a system diagram of a preferred embodiment of the invention; and

FIGS. 6A and 6B are a system diagram of a smart appliance with handheld electronic device and a circuit block diagram of the smart appliance in accordance with the prior art.

### DETAILED DESCRIPTION OF THE PREFERRED EMBODIMENT

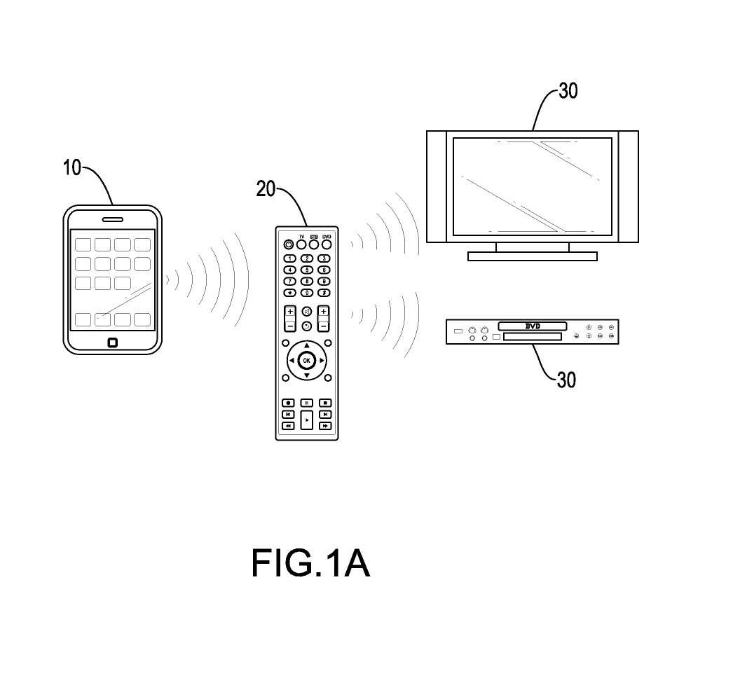

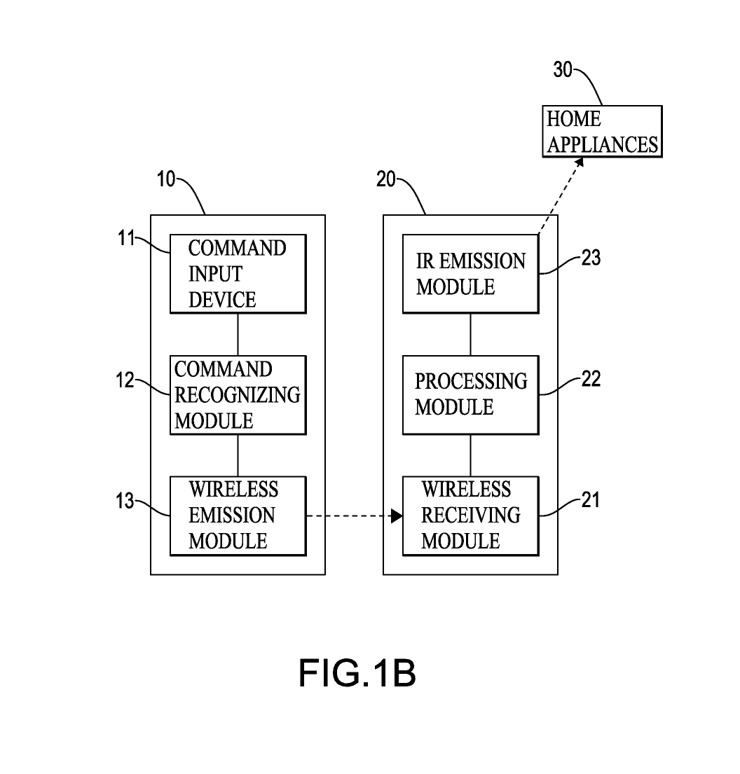

Please refer to FIGS. 1A and 1B. The disclosed remote control system using a handheld electronic device to remotely control electrical appliances can remotely control home appliances 30 with the IR remote control function. The system includes: a handheld electronic device 10 and a command conversion device 20.

The handheld electronic device 10 has a command input device 11, a command recognizing module 12, and a wireless emission module 13. The command input device 11 generates operation information. The command recognizing module 12 is coupled with the command input device 11 and the wireless emission module 13, and is built in with multiple sets of home appliance remote control codes. After receiving the operation information, the command recognizing module 12 identifies the home appliance remote control code corresponding to the operation information. Furthermore, the home appliance remote control code is processed as a wireless signal for the wireless emission module 13 to emit.

The command conversion device 20 includes a wireless receiving module 21, a processing module 22, and an IR emission module 23. The wireless receiving module 21 receives the home appliance remote control code emitted by the handheld electronic device 10. The processing module 22 is coupled with the wireless receiving module 21 and the IR emission module 23, and is built in with multiple sets of IR execution commands corresponding to the multiple sets of infrared remote control codes. After receiving the home appliance remote control code, the processing module 22 determines the IR execution command corresponding to the home appliance remote control code. The IR execution command is then emitted by the IR emission module 23.

The handheld electronic device 10 may further emit a learning command and a control code setting command. The command conversion device 20 may be further provided with an IR receiving module coupled with the processing module 22. The IR receiving module and the IR emission module 23 can be integrated into an IR transceiver module. The processing module 22 is further built in with a learning mode for executing the learning mode after receiving the learning command issued by the handheld electronic device 10. When executing the learning mode, the command conversion unit 20 receives an external IR execution command, such as the IR execution command emitted by the remote control made by another manufacturer. After receiving the control code setting command of the handheld electronic device 10, the control code setting command is used to set the home appliance remote control code corresponding to the received IR execution command. In this way, the user can use the learning mode to input the IR execution command used by the remote control made by another manufacturer into the command conversion device 20. The learning mode can further map with multiple sets of home appliance remote control codes such that the command conversion device 20 can be applied to home appliances of various brands.

Through the above means, the home appliances 30 can immediately execute an action corresponding to the received IR execution command. The application of the remote control system of the present invention is not limited to smart home appliances, but any traditional home appliance with IR remote control function is also applicable. The home appliance remote control codes can be downloaded using the application provided by the supplier of the command conversion device 20. The purpose is to enable the user to communicate with the command conversion device 20 using the home appliance remote control code.

To facilitate operational convenience, the handheld electronic device 10 can have input means such as voice input, handwriting input, and shaking gesture input, which will be further described below.

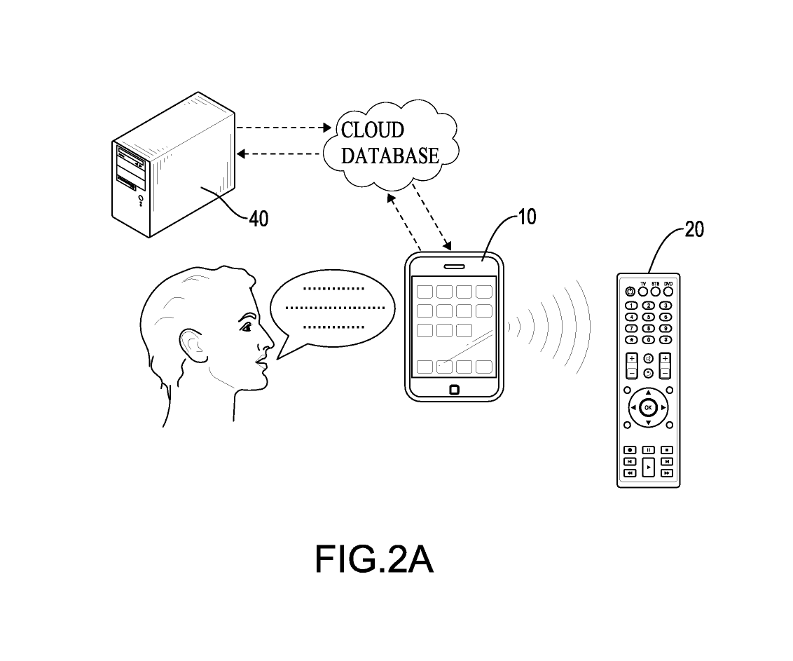

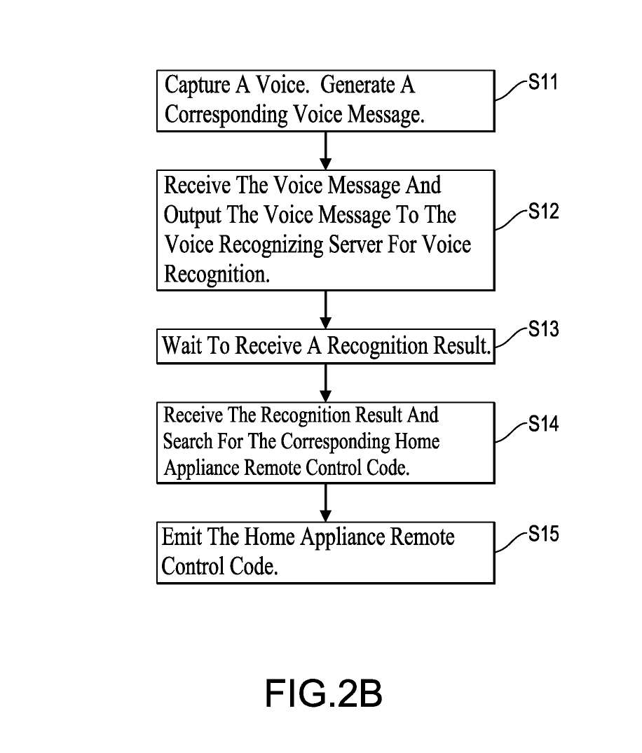

Please further refer to FIGS. 2A and 2B. When using the voice input, the command input device 11 of the handheld electronic device 10 is a voice receiving device. The command recognizing module 12 is connected to a voice recognizing server 40, which is built in with a voice database. The handheld electronic device 10 executes the following steps.

Step S11: The handheld electronic device 10 generates a voice message as the operation information after the voice receiving device extracts a voice.

The voice message is used to determine a corresponding home appliance remote control code. The command recognizing module 12 receives the voice message, and outputs the voice message to the voice recognizing server 40 (Step S12). The command recognizing module 12 waits to receive a recognition result (Step S13). In this case, the voice recognizing server 40 recognizes the voice message, and returns the recognition results to the handheld electronic device 10.

Step S14: The handheld electronic device receives the recognition result and searches for the corresponding home appliance remote control code. In the present embodiment, the received recognition result is displayed on the handheld electronic device 10 for the user to determine the correct recognition result. The user can enter a confirmation command for the command recognizing module 12 to use the confirmed command to search for the corresponding recognition result. For example, the handheld electronic device 10 captures the voice message orally sent by the user about “switch channels.” The voice message is sent to the voice recognizing server 40 for recognition. After performing fuzzy comparison, the voice recognizing server 40 may return such recognition result as “switch channels,” “turn on,” or “transmit.” After the user confirms the oral expression as “switch channels,” the command recognizing module 12 searches for the home appliance remote control code corresponding to “switch channels.”

Step S15: The wireless emission module 13 emits the home appliance remote control code.

As mentioned above, the command conversion device 20 is also built in with the home appliance remote control codes corresponding to or identical with those of the handheld electronic device 10. The command conversion device 20 is further built in with the IR command execution commands corresponding to those of the command conversion device 20. After receiving the home appliance remote control code emitted by the handheld electronic device 10, the command conversion device 20 can successively emit the corresponding IR execution command (the IR command for switching channels), and the home appliance 30 executes the corresponding action (switching channels).

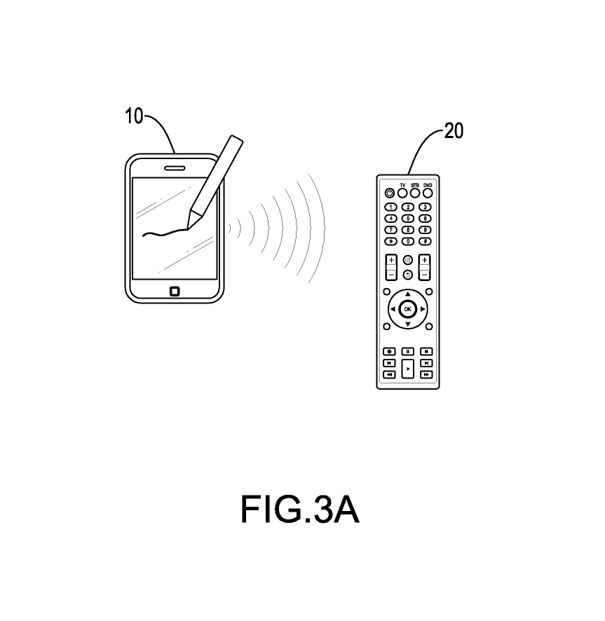

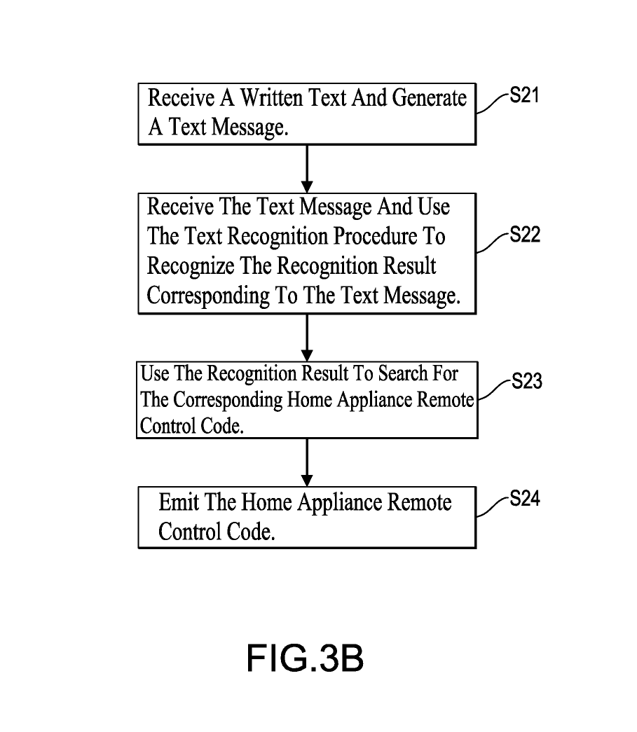

Please further refer to FIG. 3A and FIG. 3B. In the case of handwriting input, the command input device 11 of the handheld electronic device 10 is a touchpad. The command recognizing module 12 is built in with a written content recognition process. The handheld electronic device 10 executes the following steps.

After the touchpad receives a writing command, the handheld electronic device 10 generates a written message as the operation information (Step S21). The writing command can be written text or written symbols.

In Step S22, the written message is used to determine the corresponding home appliance remote control code. The command recognizing module 12 receives the written message, and the written content recognition process identifies recognition results corresponding to the written message. The recognition results are then used to search for the corresponding home appliance remote control code (Step S23). The recognition results are displayed on the handheld electronic device for the user to determine the correct recognition result. For example, the user writes “switch channels” or some specific symbol such as “v” to represent channel switch. The command recognizing module 12 begins to recognize the handwriting by using the written content recognition process. After fuzzy comparison, the text may be recognized as, for example, “switch channels” or “switch channels”, or the symbol may be recognized as, for example, “V”, “^{v}”, or “L”. The user then confirms that the written content is “switch channels” or “V” (representing channel switch). Afterwards, the command recognizing module 12 searches for the home appliance remote control code corresponding to switching channels.

In Step S24, the home appliance remote control code is emitted by the wireless emission module 13.

By means of the above Steps 21-24, remote control by handwriting is achieved.

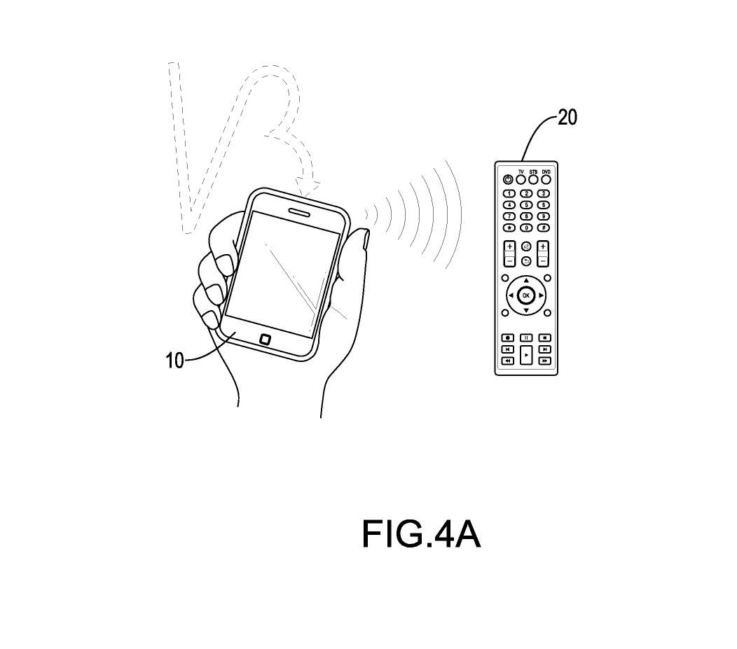

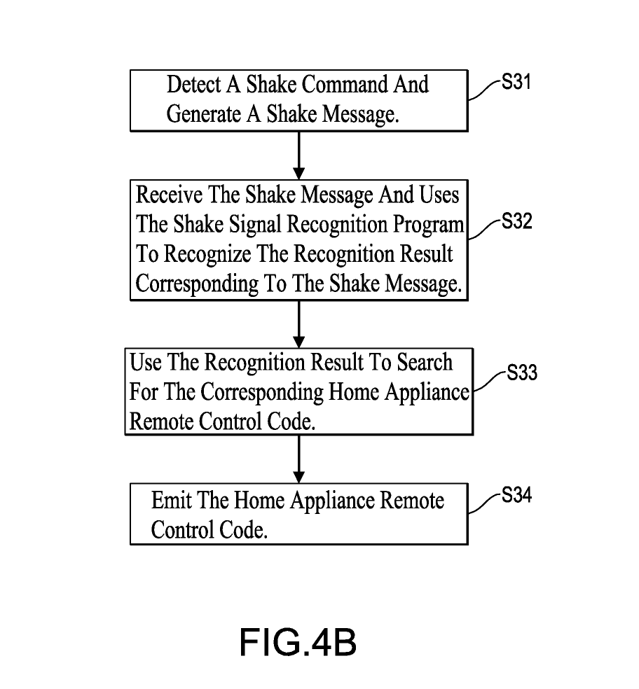

Please refer to FIGS. 4A and 4B. In the case of shaking gesture input, the command input device 11 of the handheld electronic device 10 is an acceleration sensing module. The command recognizing module 12 is built in with a shake message recognition process. The handheld electronic device 10 performs the following steps.

In Step S31, after the acceleration sensing module detects a shake command, a shake message is generated as the operating information.

The shake message is used to determine the corresponding home appliance remote control code. The command recognizing module 12 receives the shake message. The shake message recognition process determines the recognition result corresponding to the shake message (Step S32). The recognition result is used to search for the corresponding home appliance remote control code (Step S33). Likewise, the recognition result can be displayed on the handheld electronic device 10 for the user to confirm the correct recognition result. For example, a user holds the handheld electronic device 10 and gestures a number “13.” The command recognizing module 12 then starts to recognize the shake message using the shake message recognition process. After fuzzy comparison, the shake message recognition process may recognize the shake message as “13,” “73,” or “B.” After the user confirms that the shake message is “13,” the command recognizing module 12 searches for the home appliance remote control code corresponding to switching to the 13th channel.

Step S34: The home appliance remote control code is emitted by the wireless emission module 13.

The above Steps S31-34 allow the user to operate the handheld electronic device 10 by hand gestures while holding the handheld electronic device 10 in a more intuitive way with enhanced amusement.

The command recognizing module 12 of the handheld electronic device 10 can be further built in with a command setting mode. In the command setting mode, the invention first provides multiple home appliance remote control codes for the user to choose. After one of the multiple home appliance remote control codes is selected, a voice setting message, a written setting message, or a shake setting message is received for voice recognition, written messages or shake message recognition. The recognition result of the voice message (or written or shake message) is set to correspond to the selected home appliance remote control code. Therefore, the user can define personalized operations according to personal preferences (such as personal favorite voices, symbols, etc.).

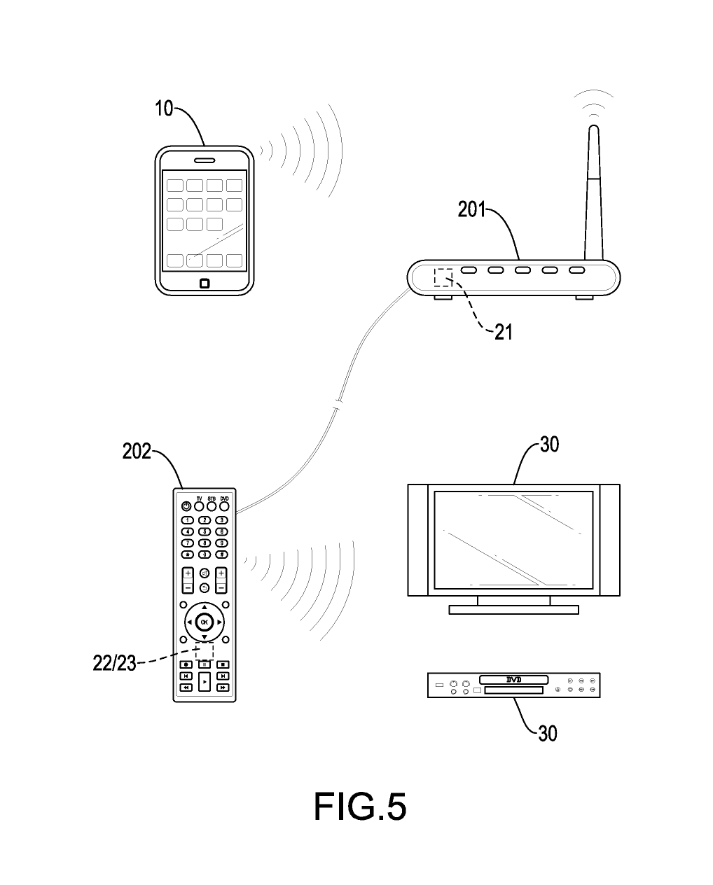

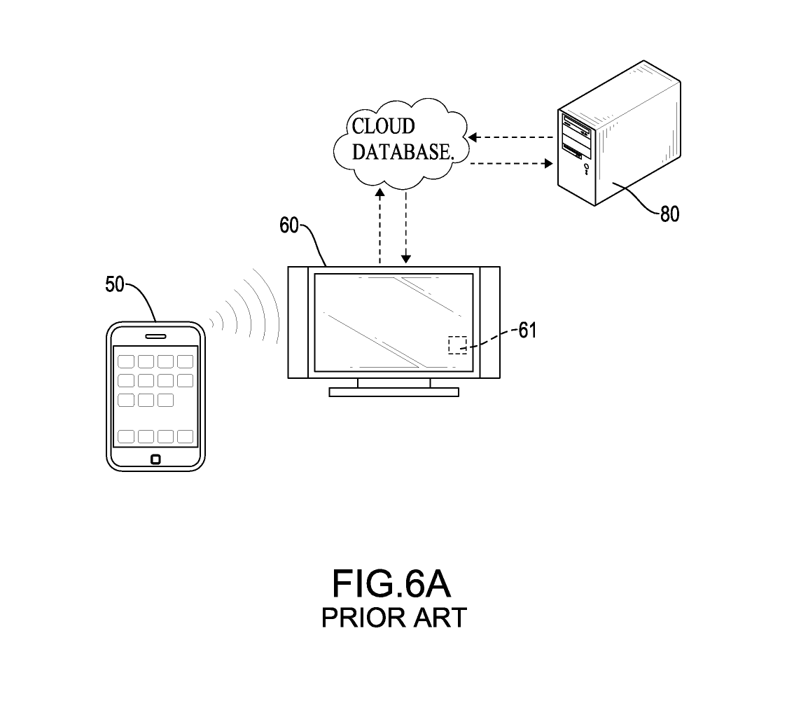

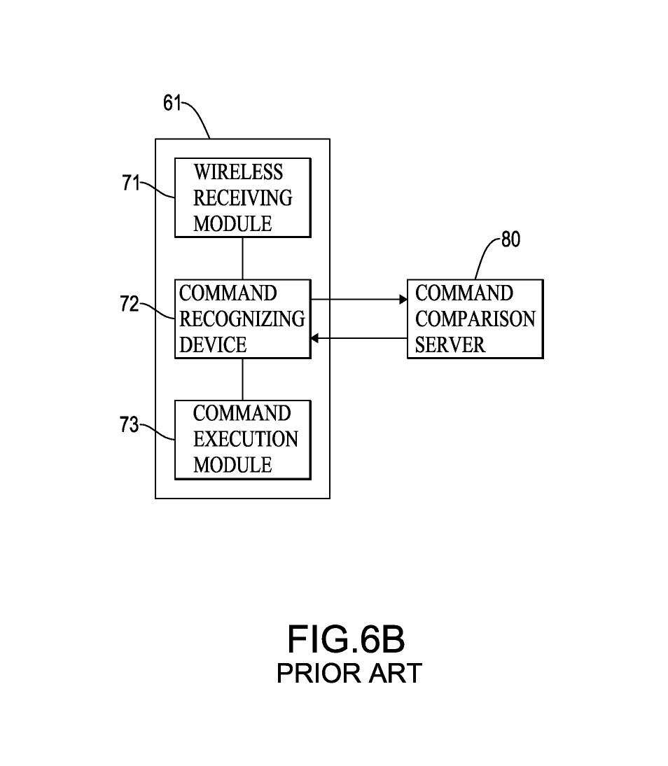

Please further refer to FIG. 5. The command conversion device 20 may comprise a signal receiver 201 and an operation emitter 202. The wireless receiving module 21 is provided in the signal receiver 201 (such as a wireless Wi-Fi/BT receiver). The processing module 22 and the IR emission module 23 are provided in the operation emitter 202. The signal receiver 201 and the operation emitter 202 are connected via a transmission line.

In practice, the remote control system using a handheld electronic device to remotely control electrical appliances requires the manufacturer to provide a command conversion device 20 and an application program. The built-in appliances remote control codes in the command conversion device 20 are set up by the manufacturer. The IR execution commands corresponding to the home appliance remote control codes are set as the IR execution commands used by either TV sets or home electrical appliances of various brands. The user can obtain the built-in home appliance remote control codes of the handheld electronic device by downloading the application program provided by the manufacturer.

With the remote control system of the invention, the user can use personal smart phones to download the above-mentioned application program. The user can then remotely control various home appliances with the command conversion device 20. In addition to various and intuitive operating modes, such as voice, handwriting, and shake gestures, the only extra equipment the user needs to purchase is the command conversion device 20. The cost is thus relatively low in comparison with purchasing smart remote controls or smart home appliances.

In summary, the disclosed remote control system using the handheld electronic device to remotely control electrical appliances provides a variety of operation modes without significantly increasing the cost, which can further facilitate market acceptance of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote control system for remotely controlling electrical appliances, the remote control system comprising:
a handheld electronic device comprising
a command input device generating operation information;
a wireless emission module; and
a command recognizing module, connected to the command input device and the wireless emission module, and storing multiple home appliance remote control codes, wherein when the command recognizing module receives the operation information and recognizes the home appliance remote control code corresponding to the operation information, the home appliance remote control code is wirelessly transmitted via the wireless emission module; and
a command conversion device comprising
a wireless receiving module receiving the home appliance remote control code from the handheld electronic device;
an infrared (IR) emission module; and
a processing module connected to the wireless receiving module and the IR emission module and storing multiple IR execution commands corresponding to the multiple home appliance remote control codes;
wherein the command conversion device receives the home appliance remote control code, determines the IR execution command corresponding to the home appliance remote control code, and emits the IR execution command via the IR emission module.

2. The remote control system as claimed in claim 1, wherein the command input device of the handheld electronic device is a voice receiving device and the command recognizing module connects to a voice recognizing server that has a voice database; and
wherein the handheld electronic device
generates a voice message as the operation information corresponding to a voice received by the voice receiving device;
determines the home appliance remote control code based on the voice message, wherein the command recognizing module of the handheld electronic device receives the voice message, outputs the voice message to the voice recognizing server, and waits to receive a recognition result from the voice recognizing server;
receives the recognition result and searches for the home appliance remote control code based on the recognition result; and
transmits the home appliance remote control code via the wireless emission module.

3. The remote control system as claimed in claim 2, wherein the command recognizing module of the handheld electronic device further has a command setting mode; and
when the command setting mode is executed, the handheld electronic device provides the multiple home appliance remote control codes to be selected by a user, receives and recognizes a voice setting message, and associates a recognition result of the voice setting message with the home appliance remote control code selected by the user.

4. The remote control system as claimed in claim 1, wherein the command input device of the handheld electronic device is a touchpad and provides a written content recognition process, with the handheld electronic device executing the steps of:
generating a written message as the operation information after the touch pad receives a written command;
using the written message to determine the home appliance remote control code corresponding to the written message, wherein the command recognizing module receives the written message, and the written content recognition process determines a recognition result corresponding to the written message and uses the recognition result to search for the home appliance remote control code corresponding to the recognition result; and
transmitting the home appliance remote control code via the wireless emission module.

5. The remote control system as claimed in claim 4, wherein the command recognizing module of the handheld electronic device further has a command setting mode; and
when the command setting mode is executed, the handheld electronic device provides the multiple home appliance remote control codes to be selected by a user, receives and recognizes a written setting message, and associates a recognition result of the written setting message with the home appliance remote control code selected by the user.

6. The remote control system as claimed in claim 1, wherein the command input device of the handheld electronic device is an acceleration sensing module and provides a shake message recognition process, with the handheld electronic device executing the steps of:
generating a shake message as the operation information after the acceleration sensing module detects a shake command;
using the shake message to determine the home appliance remote control code corresponding to the shake message, wherein the command recognizing module receives the shake message, and the shake message recognition process determines a recognition result corresponding to the shake message and uses the recognition result to search for the home appliance remote control code corresponding to the recognition result; and
transmitting the home appliance remote control code via the wireless emission module.

7. The remote control system as claimed in claim 6, wherein the command recognizing module of the handheld electronic device further has a command setting mode; and
when the command setting mode is executed, the handheld electronic device provides the home appliance remote control codes to be selected by a user, receives and recognizes a shake setting message, and associates a recognition result of the shake setting message with the home appliance remote control code selected by the user.

8. The remote control system as claimed in claim 2, wherein when the handheld electronic device uses the recognition result to search for the corresponding home appliance remote control code, the recognition result is displayed on the handheld electronic device to wait for a confirmation command, and the command recognizing module uses the recognition result corresponding to the confirmation command for searching the home appliance remote control code.

9. The remote control system as claimed in claim 4, wherein when the handheld electronic device uses the recognition result to search for the corresponding home appliance remote control code, the recognition result is displayed on the handheld electronic device to wait for a confirmation command, and the command recognizing module uses the recognition result corresponding to the confirmation command for searching the home appliance remote control code.

10. The remote control system as claimed in claim 6, wherein when the handheld electronic device uses the recognition result to search for the corresponding home appliance remote control code, the recognition result is displayed on the handheld electronic device to wait for a confirmation command, and the command recognizing module uses the recognition result corresponding to the confirmation command for searching the home appliance remote control code.

11. The remote control system as claimed in claim 1, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

12. The remote control system as claimed in claim 2, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

13. The remote control system as claimed in claim 3, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

14. The remote control system as claimed in claim 4, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

15. The remote control system as claimed in claim 5, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

16. The remote control system as claimed in claim 6, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

17. The remote control system as claimed in claim 7, wherein the command conversion device further comprises:
a signal receiver, wherein the wireless receiving module is provided in the signal receiver; and
an operation emitter connected to the signal receiver via a transmission line, wherein the processing module and the IR emission module are provided in the operation emitter.

18. The remote control system as claimed in claim 15, wherein
the handheld electronic device further emits a learning command and a control code setting command; the command conversion device further has an IR receiving module coupled with the processing module, wherein the IR receiving module and the IR emission module are integrated as an IR transceiver module;
the processing module further provides a learning mode that is executed after the learning command emitted by the handheld electronic device is received; and
the command conversion device receives an external IR execution command in the learning mode, and after receiving the control code setting command from the handheld device, associates the received IR execution command with one of the home appliance remote control codes based on the control code setting command.
